(19) United States
(12) Patent Application Publication
(10) Pub. No.: US 2015/0052386 A1
(43) Pub. Date: Feb. 19, 2015

(54) TECHNIQUE FOR REPAIRING MEMORY MODULES IN DIFFERENT POWER REGIONS

(71) Applicant: NVIDIA CORPORATION, Santa Clara, CA (US)

(72) Inventors: Sagheer AHMAD, Cupertino, CA (US); Jae WU, Los Gatos, CA (US); Sitara NERELLA, Santa Clara, CA (US); Roman SURGUTCHIK, (US)

(73) Assignee: NVIDIA CORPORATION, Santa Clara, CA (US)

(21) Appl. No.: 13/970,485

(22) Filed: Aug. 19, 2013

(51) Int. Cl. G06F 11/07

(52) U.S. Cl. CPC G06F 11/0793
USPC 714/6.12

(57) ABSTRACT

A reshift unit within a computer system is configured to store repair information associated with random-access memory (RAM) modules that reside in different power regions. When one or more RAM modules in a given power region need to be repaired, the reshift unit identifies a portion of the repair information that is relevant to those RAM modules. The reshift unit then transmits that portion to the RAM modules, thereby repairing those RAM modules. Accordingly, RAM modules in a given power region can be repaired independently of RAM modules in other power regions. Advantageously, RAM modules can be repaired between cold boots without implementing the slow repair procedure performed by the fuse block during cold boot.

### BACKGROUND OF THE INVENTION

1. Field of the Invention

Embodiments of the present invention relate generally to computer system memory and, more specifically, to a technique for repairing memory modules in different power regions.

2. Description of the Related Art

A conventional random-access memory (RAM) module is designed to include one or more redundant columns. At the time of manufacture, the RAM module is tested to identify any faulty columns. If a faulty column is identified, then one of the redundant columns can be muxed in place of the faulty column, thereby repairing the RAM module. Information that reflects which columns of a given RAM module should be muxed in place of faulty columns is referred to herein as “repair information.” Repair information may be burnt into a fuse block for later repair operations.

A modern computer chip may include many different RAM modules placed at various locations on the chip. For example, a system-on-a-chip (SoC) could include a RAM module for dedicated use by a central processing unit (CPU), another RAM module for video memory associated with a graphics processing unit (GPU), and yet another RAM module for storing application and user data. A fuse block may be included within the computer chip that stores repair information for the different RAM module on the chip.

When the computer chip is powered on during a cold boot, the repair information is read from the fuse block, and then serially shifted onto a repair chain that couples the different RAM modules together. Once all of the repair information is shifted onto the repair chain, each RAM module connected to the chain is provided with the appropriate repair information needed to mux redundant columns in place of faulty ones.

Although the conventional approach described thus far can be successfully implemented to repair RAM modules, this approach suffers from several problems. In particular, the repair information can only be shifted onto the repair chain at a very low frequency, so repairing each RAM takes a significant amount of time, resulting in a lengthy cold boot. Additionally, some RAM modules may not power on until after the repair information has been shifted onto the repair chain. Consequently, the entire repair process has to be repeated when these RAM modules finally do power on. The repair process may be quite time-consuming operation, and, during that process, the computer chip is non-operational. Finally, certain RAM modules may power on and off at different times (e.g., to conserve power) during operation. Each time a RAM module powers back on, the entire repair process must be performed, resulting in additional downtime of the computer chip.

Essentially, the conventional repair process described herein may require significant time to implement, and may need to be repeated multiple times. During that repair process, the computer chip is not operational. When the computer chip is included within a consumer device, such as a cell phone, that device may boot slowly and operate sluggishly, thereby creating a poor user experience.

Accordingly, what is needed in the art is an improved technique for repairing RAM modules.

### SUMMARY OF THE INVENTION

One embodiment of the present invention sets forth a computer-implemented method for repairing memory modules, including receiving repair information associated with a plurality of memory modules, identifying different regions of the subsystem that need to be repaired, identifying repair information that is associated with each different region of the subsystem, and transmitting the repair information to the different regions in parallel to repair faulty memory modules in the different regions.

One advantage of the disclosed technique is that RAM modules can be repaired between cold-boot operations without implementing the slow repair procedure performed by the fuse block during cold boot. Thus, power regions that include those RAM modules can be brought online more quickly, thereby increasing the overall speed with which the computer system operates.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 is a block diagram of a parallel processing unit included in the parallel processing subsystem of FIG. 1, according to one embodiment of the present invention;

FIG. 3 is a block diagram of a subsystem that is configured for repairing RAM modules across different power regions, according to one embodiment of the present invention; and

FIG. 4 is a flow diagram of method steps for repairing a RAM module included in a particular power region, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

### System Overview

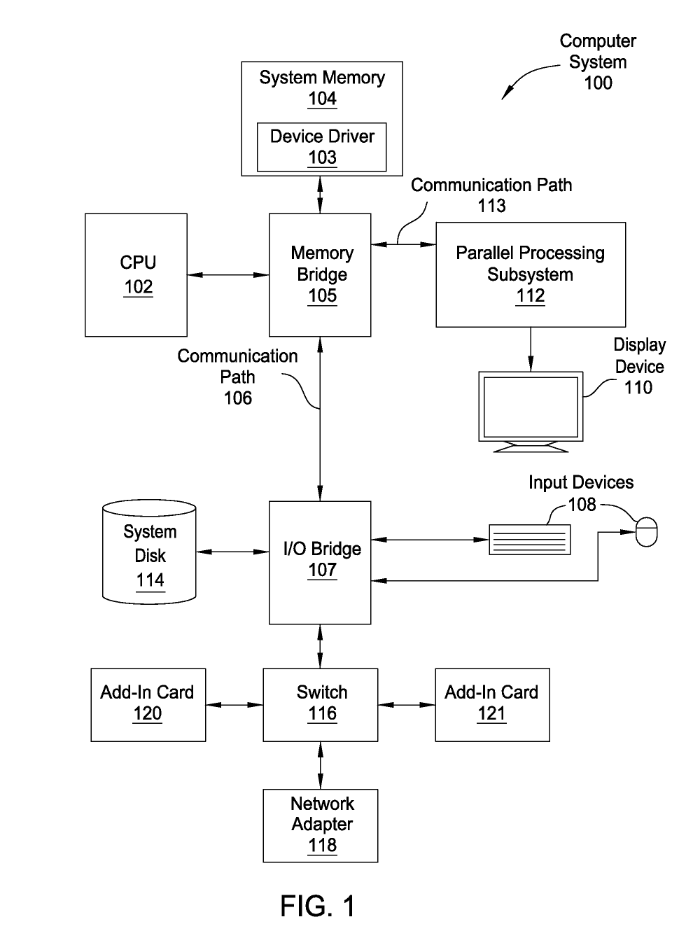

FIG. 1 is a block diagram illustrating a computer system 100 configured to implement one or more aspects of the present invention. As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In operation, I/O bridge 107 is configured to receive user input information from input devices 108, such as a keyboard or a mouse, and forward the input information to CPU 102 for processing via communication path 106 and memory bridge 105. Switch 116 is configured to provide connections between I/O bridge 107 and other components of the computer system 100, such as a network adapter 118 and various add-in cards 120 and 121.

As also shown, I/O bridge 107 is coupled to a system disk 114 that may be configured to store content and applications and data for use by CPU 102 and parallel processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

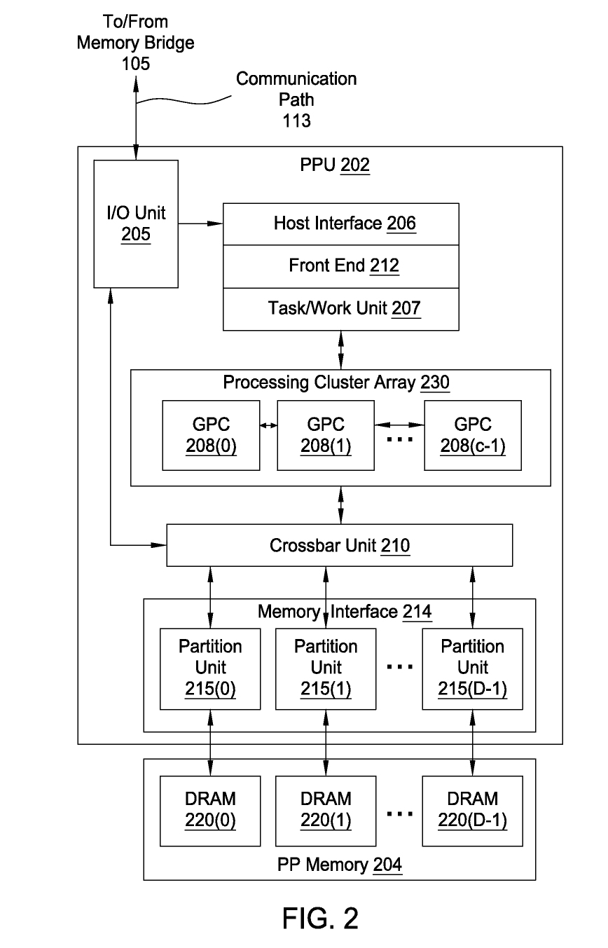

In some embodiments, parallel processing subsystem 112 comprises a graphics subsystem that delivers pixels to a display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. As described in greater detail below in FIG. 2, such circuitry may be incorporated across one or more parallel processing units (PPUs) included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver 103 configured to manage the processing operations of the one or more PPUs within parallel processing subsystem 112.

In various embodiments, parallel processing subsystem 112 may be integrated with one or more other the other elements of FIG. 1 to form a single system. For example, parallel processing subsystem 112 may be integrated with CPU 102 and other connection circuitry on a single chip to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) 202 included in the parallel processing subsystem 112 of FIG. 1, according to one embodiment of the present invention. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to display device 110 for display. In some embodiments, PPU 202 also may be configured for general-purpose processing and compute operations.

In operation, CPU 102 is the master processor of computer system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, PPU 202 includes an I/O (input/output) unit 205 that communicates with the rest of computer system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end unit 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C≧1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 includes a set of D of partition units 215, where D≧1. Each partition unit 215 is coupled to one or more dynamic random access memories (DRAMs) 220 residing within PPM memory 204. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

A given GPCs 208 may process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

As noted above, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

### Repairing Memory Modules in Different Power Regions

Computer system 100 shown in FIG. 1 may include multiple different RAM modules that provide local storage space for components within computer system 100. For example, CPU 102 could be coupled to several RAM modules that provide local storage for CPU 102. A given RAM module within computer system 100 may include one or more non-functional columns, due to, e.g., manufacturing defects, among other causes. Those non-functional columns may be detected during initial testing of the RAM module. Computer system 100 is capable of repairing the RAM module by multiplexing a redundant column of that RAM module in place of the non-functional column. Computer system 100 is configured to store repair information that indicates which redundant columns should be multiplexed in this fashion, for each different RAM module.

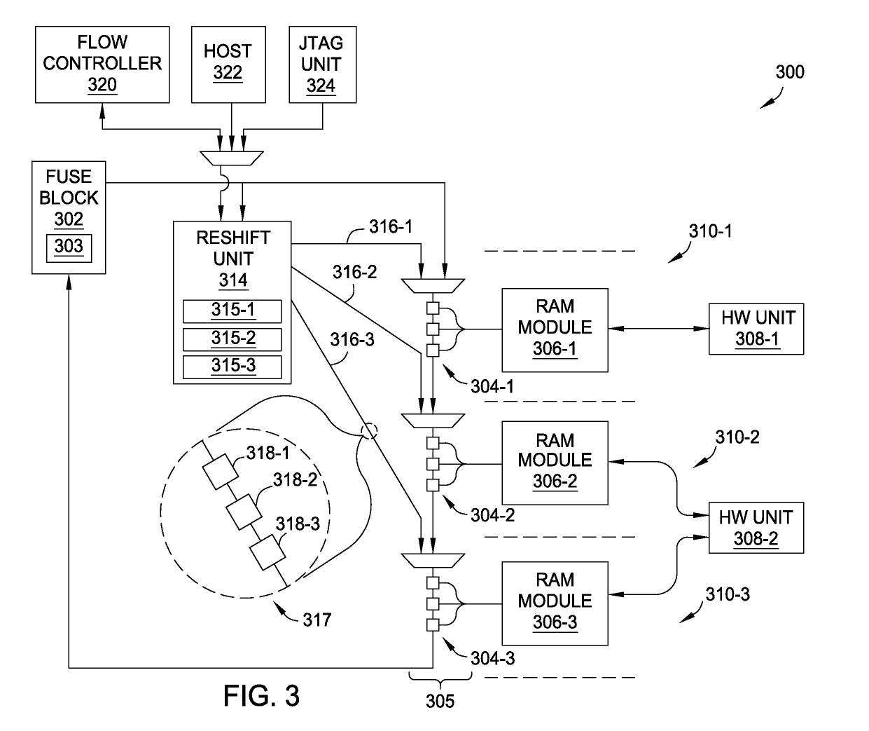

When computer system 100 initially powers on, i.e. during a cold boot, computer system 100 is configured to repair all included RAM modules by pushing the repair information onto a repair chain that connects the RAM modules to one another. In addition, computer system 100 is configured to repair individual groups of RAM modules that reside within separate power regions of computer system 100. In doing so, computer system 100 may transmit just a portion of the repair information to a given group, as described in greater detail below in conjunction with FIG. 3.

FIG. 3 is a block diagram of a subsystem that is configured for repairing RAM modules across different power regions, according to one embodiment of the present invention. Subsystem 300 resides within computer system 100 shown in FIG. 1 and may include CPU 102, also shown in FIG. 1, and PPU 202 shown in FIG. 2. In one embodiment, subsystem 300 represents a portion of a SoC included within a mobile computing device, such as a cell phone, tablet computer, and so forth, implemented by computer system 100. More generally, subsystem 300 may represent any portion of a computing device where elements of that computing device are organized into separate power regions.

As shown, subsystem 300 includes a fuse block 302 coupled to a sequence of repair flops 304. Fuse block 302 is coupled to repair flops 304-1, which, in turn, are coupled to repair flops 304-2. Repair flops 304-2 are coupled to repair flops 304-3. Each of repair flops 304 is coupled to a different RAM module 306. Repair flops 304-1 are coupled to RAM module 306-1, repair flops 304-2 are coupled to RAM module 306-2, and repair flops 304-3 are coupled to RAM module 306-3. Repair flops 304 collectively constitute a repair chain 305 that may store repair information for RAM modules 306.

Each RAM module 306 is coupled to a hardware (HW) unit 308. RAM module 306-1 is coupled to HW unit 308-1, while RAM modules 306-2 and 306-3 are both coupled to HW unit 308-2. A given HW unit 308 may be a processing unit, such as, e.g., a CPU, a GPU, a PPU, or, alternatively, a fixed-function unit, such as, e.g., a decoder engine or a digital signal processor (DSP). As a general matter, HW units 308 represent units that write data to and read data from one or more corresponding RAM modules 306.

Ram modules 306 are configured to reside within different power regions 310. RAM module 306-1 resides within power region 310-1, RAM module 306-2 resides within power region 310-2, and RAM module 306-3 resides within power region 310-3. Flops 304 coupled to a RAM module 306 generally reside within the same power region 310 as that RAM module 306. A HW unit 308 coupled to a given RAM module 306 may reside within a power region 310 associated with that RAM module 306, or may reside within a different power region 310. For example, HW unit 308-1 coupled to RAM module 306-1 could reside within power region 310-1 or a different power region. Further, HW unit 308-2 could reside within either of power regions 310-2 or 310-3, or reside within a different power region 310 altogether.

Each power region 310 may be associated with a different power rail (not shown) that provides power to the elements within the corresponding power region. Subsystem 300 may power on and off power regions 310 independently of one another. Subsystem 300 may power off a given power region 310 when the functionality provided by the elements within that power region 310 are not needed to support the overall operation of subsystem 300. When subsystem 300 is initially powered on, i.e. during a cold boot, subsystem 300 may power on some or all of power regions 310.

In addition, during a cold boot, subsystem 300 is configured to perform a repair procedure in order to repair RAM modules 306. As mentioned above, certain columns of RAM modules 306 may be non-functional, due to, e.g., manufacturing defects. By implementing the repair procedure, subsystem 300 multiplexes specific redundant columns of RAM modules 306 in place of any non-functional columns within those RAM modules.

Fuse block 302 is configured to store repair information 303 that indicates which columns of each RAM module 306 should be multiplexed in place of non-functional columns. Repair information 303 may have been burnt into fuse block 302 after initial testing of each RAM module 306 revealed which columns of those RAM modules 306 were non-functional. In order to implement the repair procedure mentioned above, fuse block 302 is configured to decode repair information 303 and then push that repair information onto repair chain 305. Fuse block 302 generally operates according to a dedicated clock, and during each clock cycle, fuse block 302 shifts a portion of repair information 303 onto repair chain 305. In one embodiment, the clock associated with fuse block 302 has a frequency of approximately 25 MHz.

Once fuse block 302 has shifted all portions of repair information 303 onto repair chain 305, each of repair flops 304 may store a portion of repair information 303 that is relevant to a corresponding RAM module 306. For example, repair flops 304-1 may store a portion of repair information 303 that corresponds to RAM module 306-1. RAM module 306-1 may then multiplex a functional, redundant column in place of a non-functional column according to that portion of repair information 303.

Fuse block 302 may implement the repair procedure described above in order to attempt to repair all RAM modules 306 within subsystem 300 during a cold boot. However, certain RAM modules 306 may not immediately be powered on during the cold boot and may remain powered off for some time. Those RAM modules 306 cannot be repaired while powered off, and so the repair procedure initially implemented by fuse block 302 may be ineffective towards repairing all RAM modules 306. In particular, flops 304 associated with a given RAM module 306 that is powered off may also be powered off, and may thus not be capable of storing repair information associated with that RAM module 306.

In addition, RAM modules 306 that were successfully repaired during the initial repair procedure may, at a later time, be powered off (e.g. the power region 310 that includes those RAM modules 306 is powered off). When powered back on, those RAM modules 306 need to be repaired again. As a general matter, certain RAM modules 306 may need to be repaired at various times during the operation of subsystem 300 after the initial repair procedure implemented by fuse block 302 has already taken place. In order to avoid performing that initial repair procedure repeatedly, subsystem 300 includes a reshift unit 314 that is configured to store portions of repair information 303 and repair RAM modules 306 within individual power regions 310, as needed.

When fuse block 302 pushes repair information 303 onto repair chain 305, reshift unit 314 is configured to read that repair information. Reshift unit 314 then stores different portions of repair information 303, where each such portion corresponds to a different power region 310. As shown, reshift unit 314 includes portions 315 of repair information 303. Portion 315-1 corresponds to power region 310-1, portion 315-2 corresponds to power region 310-2, and portion 315-3 corresponds to power region 310-3. In one embodiment, reshift unit 314 stores portions 315 in a latch array. As a general matter, a portion 315 may be used to repair one or more RAM modules 306 within a specific power region 310.

At any given time during the operation of subsystem 300, reshift unit 314 may repair any of RAM modules 306. In doing so, reshift unit 314 transmits the relevant portion 315 of repair information 303 to flops 304 coupled to the RAM module 306 in need of repair. Again, a portion 315 corresponds to a power region 310 as a whole, and, thus, reshift unit 314 is also capable of repairing more than one RAM module 306 at a time. With this approach, reshift unit 314 may repair RAM modules 306 that were not powered on when fuse block 302 performed the initial repair procedure. In addition, reshift unit 314 may repair RAM modules 306 when the power region 310 that includes those RAM modules 306 is powered down and then powered on at a later time.

Reshift unit 314 may also repair a RAM module 306 that is coupled to a hardware unit 308 configured to implement power gating. For example, HW unit 308-2 could power gate RAM modules 306-2 and 306-3. When HW unit 308-2 does not need to interact with RAM module 306-3 for a time, HW unit 308-2 could power off RAM module 306-3. HW unit 308-2 could then power on RAM module 306-3 at a later time, and, in response, reshift unit 314 would repair RAM module 306-3. In doing so, reshift unit 314 would transmit portion 315-3 of repair information 303 to flops 304-3.

In FIG. 3, reshift unit 314 is coupled to each of flops 304-1, 304-2, and 304-3 by connections 316-1, 316-2, and 316-3. Since reshift unit 314 is coupled each of flops 304-1, 304-2, and 304-3 separately, reshift unit 314 may transmit different portions 315 to those flops 304 in parallel, thereby repairing multiple different RAM modules 306 simultaneously, further increasing the speed with which RAM modules 306 may be repaired.

Each connection 316 includes one or more pipeline stages 318. As shown within inset 317, connection 316-3 includes pipeline stages 318-1, 318-2, and 318-3. Pipeline stages 318 within a given connection 316 allow data to be transmitted across that connection 316 with a higher clock speed than fuse block 302 is capable of transmitting data. Consequently, reshift unit 314 is capable of transmitting portions 315 across connections 316 faster than fuse block 302 is capable of pushing repair information 303 onto repair chain 305. In one embodiment, reshift unit 314 operates according to clock having a frequency of over 100 mHZ.

Reshift unit 314 is configured to repair RAM modules 306 within a given power region 310 in response to notifications that may be received from other units. In FIG. 3, a flow controller 320, a host 322, and a JTAG unit 324 are coupled to reshift unit 314 and configured to cause reshift unit 314 to perform repair operations.

Flow controller 320 is generally responsible for power management in subsystem 300, and is configured to notify reshift unit 314 when a power region 310 is powered on. In response, reshift unit 314 repairs that power region. Host 322 may be a software program executing on a processing unit within subsystem 300 or computer system 100. Host 322 may notify reshift unit 314 that a repair is needed in response to various events associated with the execution of program code included within host 322. Joint Test Action Group (JTAG) unit 324 is configured to perform testing and debugging operations, and may notify reshift unit 314 that a repair is needed as part of a testing procedure, among other possibilities.

By implementing the approach described herein, subsystem 300 is capable of repairing RAM modules within different power regions 310 independently of one another. Accordingly, those RAM modules may be repaired more quickly than possible with conventional approaches. In particular, reshift unit 314 is capable of repairing all RAM modules 306 in parallel with one another, instead of sequentially, as required by prior art techniques. In addition, reshift unit 314 is capable of transmitting repair information according to a faster clock than previous approaches transmit repair information. Further, since reshift unit 314 precludes the need to re-read repair information 303 between cold boots, subsystem 303 may read fuse block 302 fewer times, thereby extending the lifetime of that fuse block.

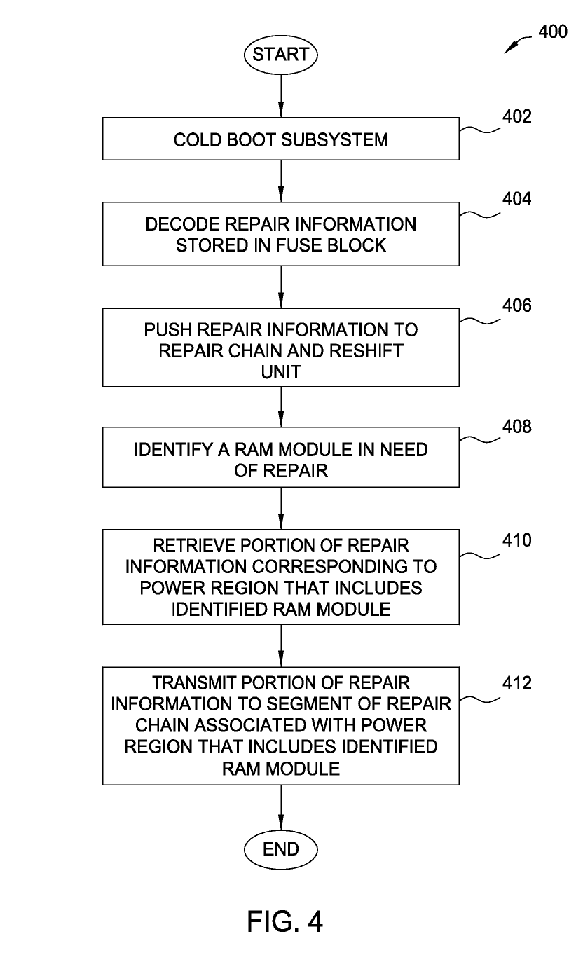

Persons skilled in the art will recognize that the configuration of elements shown in FIG. 3 is provided for illustrative purposes only and not meant to limit the scope of the invention. In particular, subsystem 300 may include any number of different power regions 310, and each such power region 310 may include any number of RAM modules 306. Likewise, reshift unit 314 may store any number of portions 315 of repair information 303 for repairing the different RAM modules 306 within subsystem 300. Again, a given portion 315 of repair information 303 may correspond to multiple different RAM modules 306 within a given power region 310, and reshift unit 314 may repair all of those RAM modules 306 by transmitting that portion 315 to the appropriate flops 304. The technique described thus far is described in greater detail below in conjunction with FIG. 4.

FIG. 4 is a flow diagram of method steps for repairing a RAM module included in a particular power region, according to one embodiment of the present invention. Although the method steps are described in conjunction with the systems of FIGS. 1-3, persons skilled in the art will understand that any system configured to perform the method steps, in any order, is within the scope of the present invention.

As shown, a method 400 begins at step 402, where subsystem 300 is cold booted. For example, a user of computer system 100 may turn on computer system 100, which initiates a cold-boot operation. At step 404, fuse block 302 decodes repair information 303. Repair information 303 indicates which columns of each RAM module 306 should be multiplexed in place of non-functional columns. Repair information 303 may have been burnt into fuse block 302 after initial testing of each RAM module 306 revealed which columns of those RAM modules 306 were non-functional.

At step 406, fuse block 302 pushes repair information 303 to repair chain 305 and to reshift unit 314. Each of repair flops 304 within repair chain 305 may store a portion of repair information 303 that is relevant to a corresponding RAM module 306. A given RAM module may then multiplex a functional, redundant column in place of a non-functional column according to that portion of repair information 303. However, certain RAM modules 306 may not immediately be powered on during cold boot and may remain powered off for some time. Those RAM modules 306 cannot be repaired while powered off, and so the repair procedure initially implemented by fuse block 302 at step 406 may be ineffective towards repairing all RAM modules 306. Upon receiving repair information 303, reshift unit 314 is configured to store repair information 303 as portions 315 of repair information 303, where each portion 315 corresponds to a different power region 310.

At step 408, reshift unit 314 identifies a RAM module 306 in need of repair. As mentioned above, the RAM module 306 could have been powered off during the initial repair procedure implemented by fuse block 302 at step 406. At step 410, reshift unit 314 retrieves a portion 315 of repair information 303 corresponding to a power region 310 that includes the identified RAM module 306. At step 412, reshift unit 314 transmits the portion 315 of repair information 303 to a segment of the repair chain 305 associated with the power region 310 that includes the identified RAM module 306. That segment of repair chain 305 includes flops 304 that are configured to store the portion 315 and then multiplex a functional, redundant column of the RAM module 306 in place of a non-functional column, thereby repairing the RAM module 306. The method 400 then ends.

Reshift unit 314 may perform steps 408, 410, and 412 of the method 400 at any given time during operation of subsystem 300 in order to repair one or more RAM modules 306 within a given power region 310. For example, if RAM module 306 that was initially repaired by fuse 302 is powered off and then on, reshift unit 314 could then perform steps 408, 410, and 412 to identify that RAM module, retrieve the relevant portion of repair information 303, and then repair that RAM module 306.

In sum, a reshift unit within a computer system is configured to store repair information associated with random-access memory (RAM) modules that reside in different power regions. When one or more RAM modules in a given power region need to be repaired, the reshift unit identifies a portion of the repair information that is relevant to those RAM modules. The reshift unit then transmits that portion to the RAM modules, thereby repairing those RAM modules. Accordingly, RAM modules in a given power region can be repaired independently of RAM modules in other power regions.

Advantageously, RAM modules can be repaired between cold-boot operations without implementing the slow repair procedure performed by the fuse block during cold boot. Thus, power regions that include those RAM modules can be brought online more quickly, thereby increasing the overall speed with which the computer system operates. Additionally, since the reshift unit precludes the need to re-read repair information from the fuse block, the lifetime of that fuse block may be extended.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the present invention is set forth in the claims that follow.

The invention claimed is:

1. A computer-implemented method for repairing a memory module, the method comprising:
receiving repair information associated with a plurality of memory modules;
identifying a first memory module included in the plurality of memory modules that needs to be repaired;
identifying a first portion of the repair information that is associated with the first memory module; and
transmitting the first portion of the repair information to the first memory module in order to repair the first memory module.

2. The computer-implemented method of claim 1, wherein the first memory module comprises a random-access memory (RAM) module.

3. The computer-implemented method of claim 2, wherein the first portion of the repair information indicates a functional column within the first memory module that should be multiplexed in place of a non-functional column in the first memory module.

4. The computer-implemented method of claim 1, wherein the first portion of the repair information comprises a portion of the repair information corresponding to a first power region that includes the first memory module.

5. The computer-implemented method of claim 1, further comprising:
identifying a second memory module included in the plurality of memory modules that needs to be repaired;
identifying a second portion of the repair information that is associated with the second memory module; and
transmitting the second portion of the repair information to the second memory module in order to repair the second memory module,
wherein the second portion of the repair information is transmitted in parallel with the first portion of the repair information.

6. The computer-implemented method of claim 1, further comprising:
decoding the repair information; and
pushing the repair information onto a repair chain based on a first clock frequency, wherein the repair chain is coupled to the plurality of memory modules.

7. The computer-implemented method of claim 6, further comprising transmitting the first portion of the repair information to the first memory module based on a second clock frequency, wherein the second clock frequency is greater than the first clock frequency.

8. The computer-implemented method of claim 1, further comprising transmitting the first portion of the repair information to the first memory module via a pipelined connection between a reshift unit configured to store the repair information and the first memory module.

9. A non-transitory computer-readable medium storing program instructions that, when executed by a processing unit, cause the processing unit to repair a memory module by performing the steps of:
receiving repair information associated with a plurality of memory modules;
identifying a first memory module included in the plurality of memory modules that needs to be repaired;
identifying a first portion of the repair information that is associated with the first memory module; and
transmitting the first portion of the repair information to the first memory module in order to repair the first memory module.

10. The non-transitory computer-readable medium of claim 9, wherein the first memory module comprises a random-access memory (RAM) module.

11. The non-transitory computer-readable medium of claim 10, wherein the first portion of the repair information indicates a functional column within the first memory module that should be multiplexed in place of a non-functional column in the first memory module.

12. The non-transitory computer-readable medium of claim 9, wherein the first portion of the repair information comprises a portion of the repair information corresponding to a first power region that includes the first memory module.

13. The non-transitory computer-readable medium of claim 9, further comprising the steps of:
identifying a second memory module included in the plurality of memory modules that needs to be repaired;
identifying a second portion of the repair information that is associated with the second memory module; and
transmitting the second portion of the repair information to the second memory module in order to repair the second memory module,
wherein the second portion of the repair information is transmitted in parallel with the first portion of the repair information.

14. The non-transitory computer-readable medium of claim 9, further comprising the steps of:
decoding the repair information; and
pushing the repair information onto a repair chain based on a first clock frequency, wherein the repair chain is coupled to the plurality of memory modules.

15. The non-transitory computer-readable medium of claim 14, further comprising the step of transmitting the first portion of the repair information to the first memory module based on a second clock frequency, wherein the second clock frequency is greater than the first clock frequency.

16. The non-transitory computer-readable medium of claim 9, further comprising the step of transmitting the first portion of the repair information to the first memory module via a pipelined connection between a reshift unit configured to store the repair information and the first memory module.

17. A subsystem for repairing a memory module, including:
a processing unit configured to:
receive repair information associated with a plurality of memory modules;
identify a first memory module included in the plurality of memory modules that needs to be repaired;
identify a first portion of the repair information that is associated with the first memory module; and
transmit the first portion of the repair information to the first memory module in order to repair the first memory module.

18. The subsystem of claim 17, further including:
a memory unit coupled to the processing unit and storing program instructions that, when executed by the processing unit, cause the processing unit to:
receive the repair information;
identify the first memory module;
identify the first portion of the repair information; and
transmit the first portion of the repair information to the first memory module.

19. The subsystem of claim 17, wherein the first memory module comprises a random-access memory (RAM) module, and wherein the first portion of the repair information indicates a functional column within the first memory module that should be multiplexed in place of a non-functional column in the first memory module.

20. The subsystem of claim 18, wherein the processing unit is further configured to:
identify a second memory module included in the plurality of memory modules that needs to be repaired;
identify a second portion of the repair information that is associated with the second memory module; and
transmit the second portion of the repair information to the second memory module in order to repair the second memory module,
wherein the second portion of the repair information is transmitted in parallel with the first portion of the repair information.
